(19) United States
(12) Patent Application Publication
(10) Pub. No.: US 2018/0239486 A1
(43) Pub. Date: Aug. 23, 2018

(54) CONTROL METHOD, ELECTRONIC BLACKBOARD SYSTEM, DISPLAY DEVICE, AND PROGRAM

(71) Applicant: NEC Display Solutions, Ltd., Tokyo (JP)

(72) Inventor: Yasushi HIKICHI, Tokyo (JP)

(21) Appl. No.: 15/750,094

(22) PCT Filed: Oct. 29, 2015
(86) PCT No.: PCT/JP2015/080563

§ 371 Date: Feb. 2, 2018

(51) Int. Cl. G06F 3/041; G06F 3/0482; G06F 3/0488; G06F 3/0481; G06K 9/00; G06K 9/46

(52) U.S. Cl. CPC G06F 3/0416; G06F 3/0482; G06K 9/4652; G06F 3/04817; G06K 9/00389; G06F 3/04883

(57) ABSTRACT

A control device configured to control a display device using an input object (e.g. a finger or a hand of a person, or a pen) includes detecting a touch operation using the input object, capturing an image including at least part of the input object, and determining a process to be executed based on the detection result of the detecting and the captured image of the image capturing.

### TECHNICAL FIELD

The present invention relates to a control method, an electronic blackboard system, a display device, and a program.

### BACKGROUND ART

Patent Literature 1 discloses an electronic blackboard system having the following functions. The electronic blackboard system disclosed in Patent Literature 1 has the functions to detect the color of an input object from the captured image of the input object used for specifying coordinates and to reflect the detection result in colors rendered on the computer-operating screen.

### CITATION LIST

### Patent Literature

Patent Literature 1: International Publication WO 2012/026347

### SUMMARY OF INVENTION

### Technical Problem

For example, the electronic blackboard system disclosed in Patent Literature 1 eliminates the necessity of selecting colors on an on-screen display menu. In addition, the electronic blackboard system disclosed in Patent Literature 1 eliminates the necessity of preparing multiple specially-designed pens for specifying colors. Therefore, it is possible to simplify the operation and the configuration by way of the electronic blackboard system disclosed in Patent Literature 1.

The electronic blackboard system disclosed in Patent Literature 1 aims to automatically set the rendered color to the original color of an input object. For this reason, it is not easy for the electronic blackboard system disclosed in Patent Literature 1 to set the rendered color differently from the original color of an input object; hence, it suffers from a problem for degrading operability.

The present invention is made in consideration of the aforementioned circumstances, and therefore it aims to provide a control method, an electronic blackboard system, a display device, and a program, which can solve the above problem.

### Solution to Problem

To solve the above problem, an aspect of the present invention is directed to a control method, which includes a touch detecting step for detecting a touch operation using an input object; an image capturing step for capturing an image including at least part of the input object; and a process determination step for determining a process to be executed depending on the detection result of the touch detecting step and the captured image of the image capturing step.

Another aspect of the present invention is directed to an electronic blackboard system, which includes a detector configured to detect a touch operation using an input object; an image capture part configured to capture an image including at least part of the input object; a controller configured to determine a process depending on a detection result of the detector and a captured image of the image capture part; and a display configured to display an image according to the process determined by the controller.

A further aspect of the present invention is directed to a display device, which includes a display configured to display an image according to a process determined by a controller configured to determine the process to be executed depending on the detection result of a detector configured to detect a touch operation using an input object and the captured image of an image capture part configured to capture an image including at least part of the input object.

A still further aspect of the present invention is directed to a program causing a computer to implement a touch detecting step for detecting a touch operation using an input object; an image capturing step for capturing an image including at least part of the input object; and a process determination step for determining a process to be executed depending on the detection result of the touch detecting step and the captured image of the image capturing step.

### Advantageous Effects of Invention

According to the present invention, it is possible to determine the process to be executed based on the touch-detection result and the acquired image; hence, it is possible to improve operability with ease.

### BRIEF DESCRIPTION OF DRAWINGS

FIG. 1 is a block diagram showing an example of the configuration according to the first embodiment of the present invention.

FIG. 2 is a block diagram showing an example of the configuration according to the second embodiment of the present invention.

FIG. 3 is a schematic diagram for explaining an example of the operation according to the second embodiment of the present invention.

FIG. 4 is a schematic diagram for explaining an example of the operation according to the second embodiment of the present invention.

FIG. 5 is a schematic diagram for explaining an example of the operation according to the second embodiment of the present invention.

FIG. 6 is a schematic diagram for explaining an example of the operation according to the second embodiment of the present invention.

FIG. 7 is a schematic diagram for explaining an example of the operation according to the second embodiment of the present invention.

FIG. 8 is a schematic diagram for explaining an example of the operation according to the second embodiment of the present invention.

FIG. 9 is a chart illustrating an example of the stored content of a coordinate storage media 16 according to the second embodiment of the present invention.

FIG. 10 is a flowchart showing an example of the operation according to the second embodiment of the present invention.

FIG. 11 is a schematic diagram for explaining an example of the operation according to the second embodiment of the present invention.

FIG. 12 is a schematic diagram for explaining an example of the operation according to the second embodiment of the present invention.

FIG. 13 is a schematic diagram for explaining an example of the operation according to the second embodiment of the present invention.

FIG. 14 is a schematic diagram for explaining an example of the operation according to the second embodiment of the present invention.

FIG. 15 is a schematic diagram for explaining an example of the operation according to the second embodiment of the present invention.

FIG. 16 is a schematic diagram for explaining an example of the operation according to the second embodiment of the present invention.

FIG. 17 is a schematic diagram for explaining an example of the operation according to the second embodiment of the present invention.

FIG. 18 is a schematic diagram for explaining an example of the operation according to the second embodiment of the present invention.

FIG. 19 is a schematic diagram for explaining an example of the operation according to the second embodiment of the present invention.

FIG. 20 is a schematic diagram for explaining an example of the operation according to the second embodiment of the present invention.

FIG. 21 is a block diagram showing an example of the configuration according to the third embodiment of the present invention.

### DESCRIPTION OF EMBODIMENTS

### First Embodiment

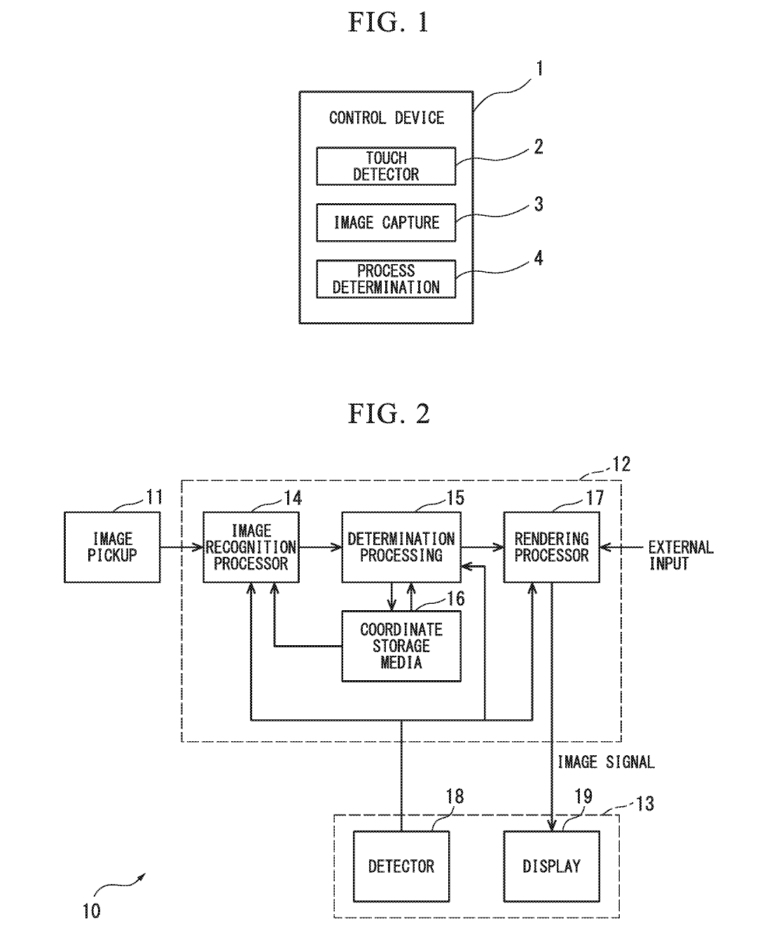

Hereinafter, the first embodiment of the present invention will be described with reference to the drawings. FIG. 1 is a block diagram showing an example of the configuration according to the first embodiment of the present invention. FIG. 1 shows a control device 1 according to the first embodiment, which includes a touch detector 2, an image capture part 3, and a process determination part 4.

For example, the control device 1 may be embodied using one or multiple computers, a peripheral device of a computer, and programs executed on a computer. Herein, the computer may be a personal computer or a terminal such as a smartphone, or it may be an embedded computer such as a micro-controller. For example, the peripheral device may include a detection device for detecting a touch operation. Alternatively, the peripheral device may include an interface for inputting or outputting signals with a detection device without including the detection device for detecting a touch operation. For example, the peripheral device may include an imaging device for capturing images. In addition, the peripheral device may include an interface for inputting or outputting signals with the imaging device. For example, the peripheral device may include a display device for displaying images. In addition, the peripheral device may include an interface for inputting or outputting signals with the display device. The display device displays images according to the process determined by the process determination part 4, which will be described later. In this connection, the touch detector 2, the image capture part 3, and the process determination part 4 represent the functions realized using the computer and its peripheral device by executing predetermined programs on the computer. The present invention refers to functional blocks as the blocks corresponding to the functions of the image capture part 3 and the process determination part 4.

The touch detector 2 detects touches on the detection screen by means of an input object such as a user's finer or hand and a pen or it may receive signals representing detection results. The touch detector 2 sends to the process determination part 4 the information representing that the detection screen is being touched and the information representing one or multiple positions of the touch screen being touched. For example, the touch detector 2 includes a display device and a detection device for detecting touch operations on a touch panel. Alternatively, the touch detector 2 may be an input interface for inputting signals output from a detection device for detecting touch operations.

The image capture part 3 captures an image including at least part of a subject indicating an input object being touched or to be touched with the touch detector 2. Herein, an image including at least part of an input object represents an image including part of an input object to the extent of extracting feature data of an input object. When an input object is a user's finger, for example, the image may cover the scope of a user ranging from a fingertip to a wrist. For example, the image capture part 3 includes an imaging device. Alternatively, the image capture part 3 may be an input interface for inputting image data output from an imaging device.

The process determination part 4 determines a process to be executed depending on the detection result of the touch detector 2 and an image captured by the image capture part 3. The entity for executing the process determined by the process determination part 4 may be the process determination part 4 or a functional block different from the process determination part 4, or it may be shared by both of them. For example, the process to be executed would be a rendering process. In this case, the process determination part 4 determines the details of a rendering process depending on the detection result of the touch detector 2 and an image captured by the image capture part 3. When the process determination part 4 renders characters or lines responsive to touch operations, for example, it should determine rendering colors and the shape of a rendering pen. Alternatively, the process to be executed would be the process that recognizes an operation of the input object on the detection screen as an operation of a virtual mouse so as to generate and output the information representing the recognized mouse operation. In this case, the process determination part 4 determines the details of the information representing the clicked condition of a mouse and the position of a mouse, which is generated based on the detection result of the touch detector 2 and an image captured by the image capture part 3. In this connection, the process determined by the process determination part 4 should not be limited to these examples.

In the control device having the above configuration, the touch detector 2 executes a touch detecting step for detecting a touch operation by an input object or for inputting the detection result of a touch operation. In addition, the image capture part 3 executes an image capturing step for capturing an image reflecting at least part of an input object. Subsequently, the process determination part 4 executes a process determination step for determining the process to be executed based on the detection result of the touch detecting step and the image captured by the image capturing step. Therefore, it is possible for the present embodiment to determine the process to be executed based on the result of detecting a touch operation and the captured image. Thus, it is possible to flexibly deal with various processes and to thereby improve operability with ease.

### Second Embodiment

Next, the second embodiment of the present invention will be described with reference to the drawings. FIG. 2 is a block diagram diagrammatically showing an example of the configuration of an electronic blackboard system 10. The electronic blackboard system 10 shown in FIG. 2 includes an image pickup part 11, a controller 12, and a touch panel 13. In the interpretation of the electronic blackboard system 10 shown in FIG. 2, for example, the entirety of the electronic blackboard system 10 may be regarded as the second embodiment of the present invention, or the controller 12 may be solely regarded as the second embodiment of the present invention. Alternatively, a combination of the image pickup part 11 and the controller 12 or a combination of the controller 12 and the touch panel 13 can be regarded as the second embodiment of the present invention. Moreover, a display 19 configured to display images according to image signals input from the controller 12 could be regarded as the second embodiment of the present invention. In this case, for example, the display 19 is not necessarily equipped with the image pickup part 11, the controller 12, and a detector 18 which will be described later, and therefore it is possible to configure a display device equipped with the display 19.

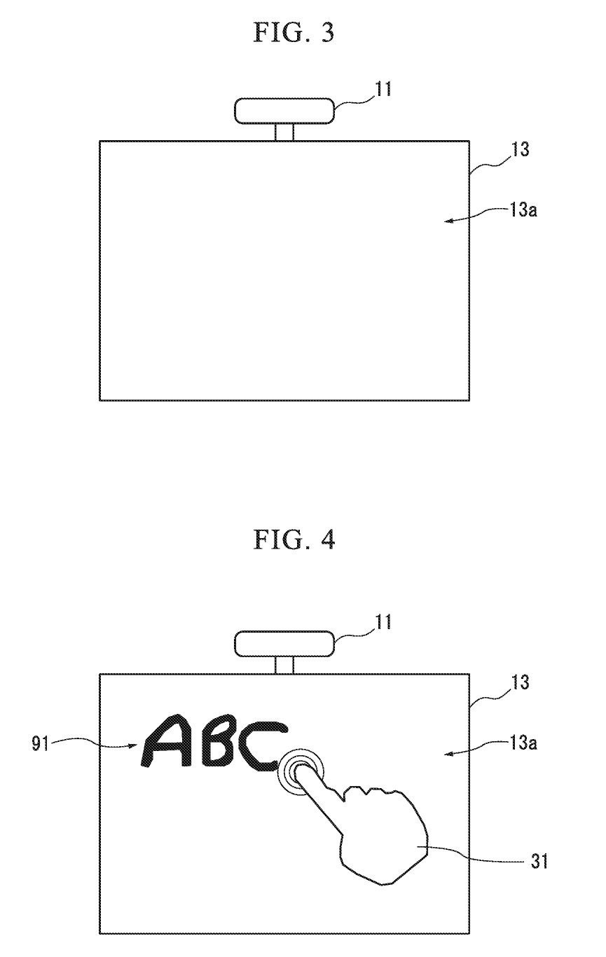

For example, the image pickup part 11 corresponds to a camera attached to a touch panel 13 shown in FIG. 3. The image pickup part 11 obtains an image in a region including an operational field on a screen 13a of the touch panel 13. That is, the image pickup part 11 obtains an image including at least part of an input object subjected to an input operation with the detector 18. The image pickup part 11 may normally produce moving images; it may repeatedly produce still images in a certain period; or it may produce moving images or still images upon receiving control signals from the controller 12, which are not shown in the drawing.

The image pickup part 11 may include multiple cameras. Multiple cameras can be attached to the upper side of the display 19 as well as the right side or the left side of the display 19. In this case, it is possible to capture images of an input object in different directions; hence, it is possible to accurately determine the shape and color of the input object. In addition, one or multiple cameras should be fixed at positions for capturing images of an input object in a region including an operational field; hence, they do not need to be attached to the touch panel 13.

The touch panel 13 having the detector 18 is attached to the display 19. The touch panel 13 and the display 19 can be integrally combined as a single device. The display 19 displays images according to image signals input from the controller 12. For example, the display 19 displays images according to a rendering process determined by the controller 12. For example, the display 19 is a liquid-crystal display. The detector 18 detects a touch operation on the screen 13a of the touch panel 13, i.e. the display screen of the display 19, by means of an input object such as a user's finger and a pen. The detector 18 outputs signals representing the presence/absence of touching and the touched position to the controller 12 as its detection result. For example, the detector 18 is a touch pad formed as a transparent screen on the display screen of a liquid crystal display.

The controller 12 is a computer, for example, which includes a CPU (Central Processing Unit), a storage device including volatile memory and nonvolatile memory, an input/output interface, and a communication device. The controller 12 includes an image recognition processor 14, a determination processing part 15, a rendering processor 17, and a coordinate storage media 16. The image recognition processor 14, the determination processing part 15, the rendering processor 17, and the coordinate storage media 16 are illustrated as the foregoing functional blocks.

The image recognition processor 14 temporarily stores image data obtained from the image pickup part 11 on a storage device inside the controller 12. The image recognition processor 14 carries out a process of recognizing the shape and color (i.e. the shape and/or the color) of an input object from an image which is captured when the detector 18 detects a touch operation of the input object. The image recognition processor 14 compares feature data representing shaping extracted from an image serving as a recognized subject with feature extracting data of an input object which are stored on the coordinate storage media 16 in advance, and therefore the image recognition processor 14 produces the identification information of the feature extracting data showing a high similarity as its detection result. Alternatively, the image recognition processor 14 compares pixel values for each color component occupying a certain region in an image serving as a recognized subject with pixel values for each color component stored in advance, and therefore the image recognition processor 14 produces the identification information for the color showing a high similarity as its detection result.

The determination processing part 15 determines the details of a rendering process for the display 19 based on the detection result of the detector 18 and the recognition result of the image recognition processor 14. As shown in FIG. 4, when a shape 91 is input to the screen 13a by use of an input object 31, for example, the determination processing part 15 controls the rendering processor 17 to render the shape 91 with the color that is set in coordination with the feature extracting data resembling the feature data of the input object 31. FIG. 4 shows an example of the input object 31 corresponding to a user's hand, i.e. an index finger of his/her right hand touching the screen 13a. In addition, the rendered color is black. In this connection, an input to the screen 13a indicates touching of an input object on the screen 13a or moving of an input object touching on the screen 13a.

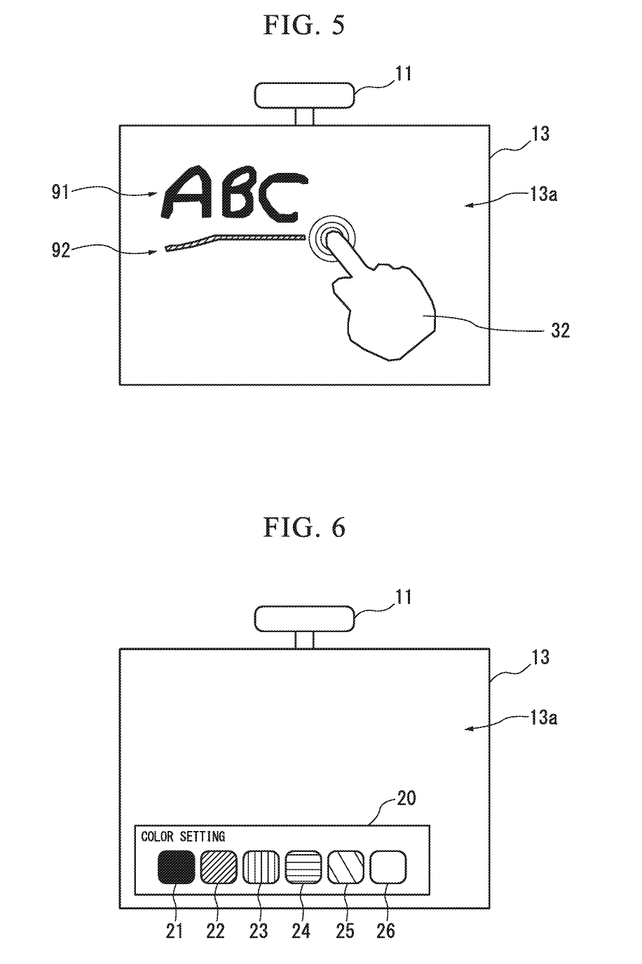

As shown in FIG. 5, when a shape 92 is input to the screen 13a by use of an input object 32, for example, the determination processing part 15 controls the rendering processor 17 to render the shape 92 with the color which is set in coordination with the feature extracting data resembling the feature data of the input object 32. FIG. 5 shows an example of the input object 32 corresponding to a user's hand, i.e. a middle finger of his/her right hand touching on the screen 13a. Herein, the rendered color is red.

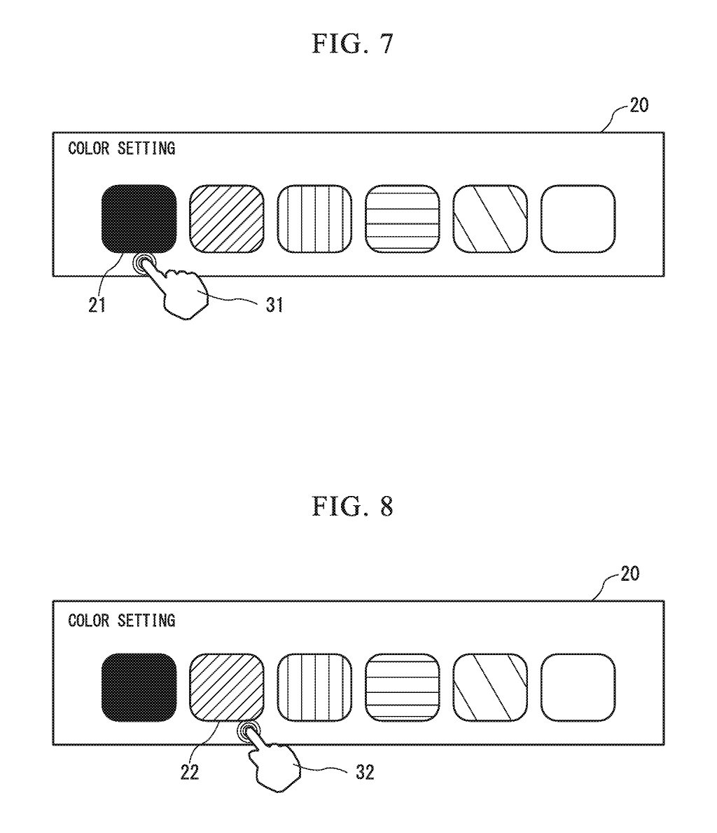

The determination processing part 15 sets the coordination between the shape and color of the recognized input object and the details of a rendering process based on the detection result of the detector 18 and the shape and color of the input object recognized by the image recognition processor 14. According to the setting, for example, the determination processing part 15 controls the rendering processor 17 to display a color setup menu 20 on the screen 13a. For example, the color setup menu 20 can be displayed on screen when a user presses a button on the touch panel 13 which is not shown or when a user performs a specific gesture with the image pickup part 11. The color setup menu 20 shown in FIG. 6 includes a black icon 21, a red icon 22, a blue icon 23, a green icon 24, a yellow icon 25, and a white icon 26. As shown in FIG. 7, when the input object 31 touches the black icon 21, for example, the determination processing part 15 stores the setting information representing the coordination between black and feature data of the input object 31 on the coordinate storage media 16. As shown in FIG. 8, when the input object 32 touches the red icon 22, for example, the determination processing part 15 stores the setting information representing the coordination between read and feature data of the input object 32 on the coordinate storage media 16.

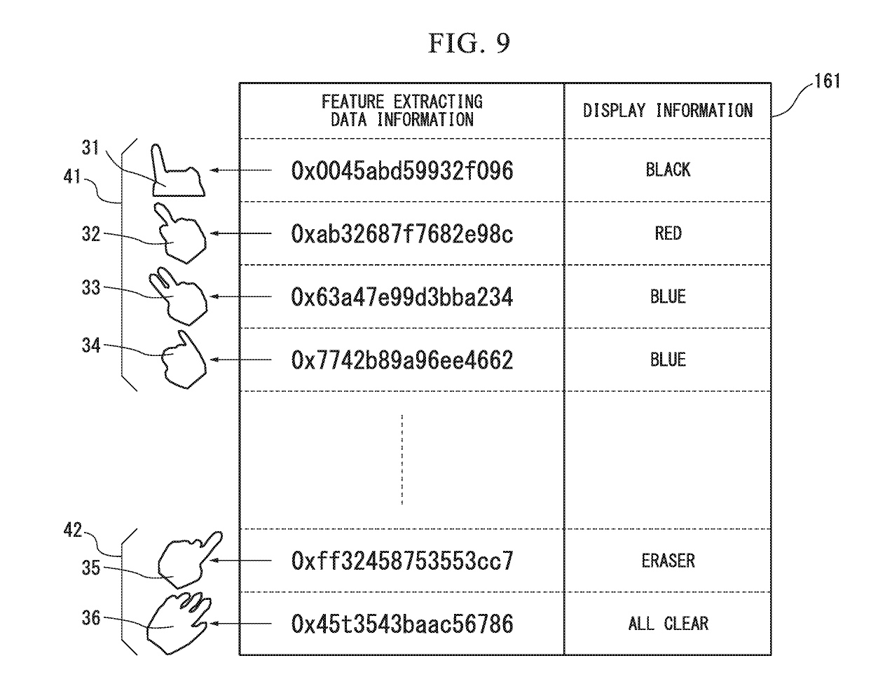

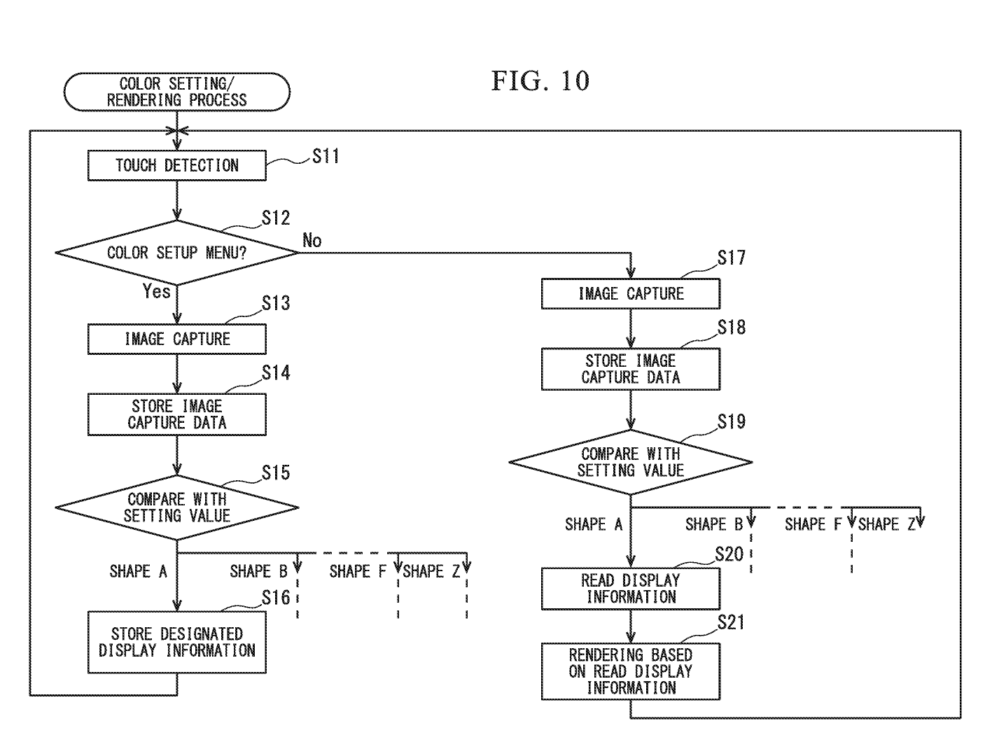

The coordinate storage media 16 stores the information representing the coordination between the information representing the shape and color of an input object and the details of processing. FIG. 9 shows a table 161 showing the coordination between the feature extracting data information and the display information. Herein, the feature extracting data information means the information of data extracting the features of an input object such as its shape and its color. The display information means the information representing the details of a rendering process, e.g. a process of eliminating the rendered color or the rendered image. For the sake of explanation, FIG. 9 shows the input objects 31 through 36, i.e. measures of extracting features when generating feature extracting data information, in connection with arrows. Herein, the input objects 31 through 34 are related to a right hand 41 while the input objects 35 and 36 are related to a left hand 42.

In FIG. 9, the input object 31 having the shape of an index finger of a right hand touching the screen 13a is correlated to the feature extracting data information of “0045abd59932a096” in hexadecimal notation, wherein the feature extracting data information is coordinated with the display information representing the rendering color “black”. For example, the input object 35 having the shape of an index finger of a left hand touching the screen 13a is correlated to the feature extracting data information, which is coordinated with the display information representing “eraser”, i.e. a process of deleting rendering on the touched area. In addition, the input object 36 having the shape of an expanded left hand touching the screen 13a is correlated to the feature extracting data information, which is coordinated with the display information representing “all clear”, i.e. a process of deleting rendering on the entire area of the screen 13a.

Before a user carries out the aforementioned setting process, for example, it is possible to store on the coordinate storage media 16 multiple sets of coordination between the typical feature extracting data information and the display information in the shipping stage of products.

The rendering processor 17 shown in FIG. 2 generates an image signal to be displayed on the display 19 under the control of the determination processing part 15, thus outputting the generated image signal to the display 19. Upon receiving a video signal from an external device, the rendering processor 17 is able to generate an image signal superposing the input video signal on the image rendered under the control of the determination processing part 15.

Next, an example of the operation of the electronic blackboard system 10 shown in FIG. 2 will be described with reference to a flowchart shown in FIG. 10. In FIG. 10, a series of steps S13 through S16 are related to a color setting process while a series of steps S17 through S21 are related to a rendering process. In addition, it is assumed that the coordinate storage media 16 have already stored feature data of input objects having shapes A through F or a shape Z.

When the detector 18 detects a touch on the screen 13a by an input object (step S11), the determination processing part 15 determines whether or not the color setup menu 20 is displayed on screen (step S12). When the color setup menu 20 is displayed on screen (i.e. Yes in step S12), the image recognition processor 14 obtains an image captured by the image pickup part 11 (step S13) and thereby stores the image on a predetermined memory device so as to execute an image recognition process (step S14). Next, the determination processing part 15 compares the recognition result of the image recognition processor 14 with the setting value of the feature extracting data (i.e. the feature extracting data information) of an input object already stored on the coordinate storage media 16 (step S15). In step S15, for example, the determination processing part 15 may compares the recognition result and the setting value according to the table-lookup method.

When the recognized shape of an input object is determined to show the highest similarity to the shape A (i.e. shape A in step S15), the determination processing part 15 registers the color information, which a user designates on the color setup menu 20, in the display information coordinated with the feature extracting data information of the shape A (step S16). As shown in FIG. 7, when the input object 31 touches the black icon 21, for example, the determination processing part 15 registers black as the display information coordinated with the feature extracting data information of the input object 31 as shown in FIG. 9. Thereafter, the processing returns to step S11 after step S16.

On the other hand, when the color setup menu 20 is not displayed on screen (i.e. No in step S12), the image recognition processor 14 obtains an image captured by the image pickup part 11 (step S17) and thereby stores the image on a predetermined memory device so as to execute image recognition (step S18). Next, the determination processing part 15 compares the recognition result of the image recognition processor 14 with the setting data of the feature extracting data of an input object already stored on the coordinate storage media 16 (step S19). In step S19, for example, the determination processing part 15 may compare the recognition result and the setting value according to the table-lookup method.

When the recognized shape of an input object is determined to be most similar to the shape A (i.e. shape A in step S19), the determination processing part 15 reads the color information registered with the coordinate storage media 16 as the display information coordinated with the feature extracting data information of the shape A (step S20). Next, the determination processing part 15 controls the rendering processor 17 to execute a rendering process using the color designated by the color information read from the coordinate storage media 16 (step S21). When the shape 91 is input by means of the input object 31 as shown in FIG. 4, for example, the determination processing part 15 proceeds to rendering the shape 91 in black. Thereafter, the processing returns to step S11 after step S21.

According to the aforementioned operation, for example, it is possible to write an image in black by touching the screen 13a with an index finger of a right hand, while it is possible to write an image in red by touching the screen 13a with a middle finger of a right hand. In addition, it is possible for a user to arbitrarily set the correspondence between the shape and the color of an input object.

As described above, the second embodiment allows the detector 18 to detect a touch operation of an input object. The image pickup part 11 captures an image including at least part of an input object. The controller 12 determines a process to be executed based on the detection result of the detector 18 and the captured image of the image pickup part 11. In addition, the display 19 displays an image according to the process determined by the controller 12. Therefore, it is possible to improve operability with ease according to the second embodiment that can determine the process to be executed based on the result of detecting a touch operation and the captured image.

For example, the second embodiment can be modified as follows. In step S16 of FIG. 10, for example, it is possible to update the stored content of the coordinate storage media 16. That is, the determination processing part 15 may rewrite feature extracting data information for the shape, which is determined to show the highest similarity, based on the recognition result of an image obtained in step S13.

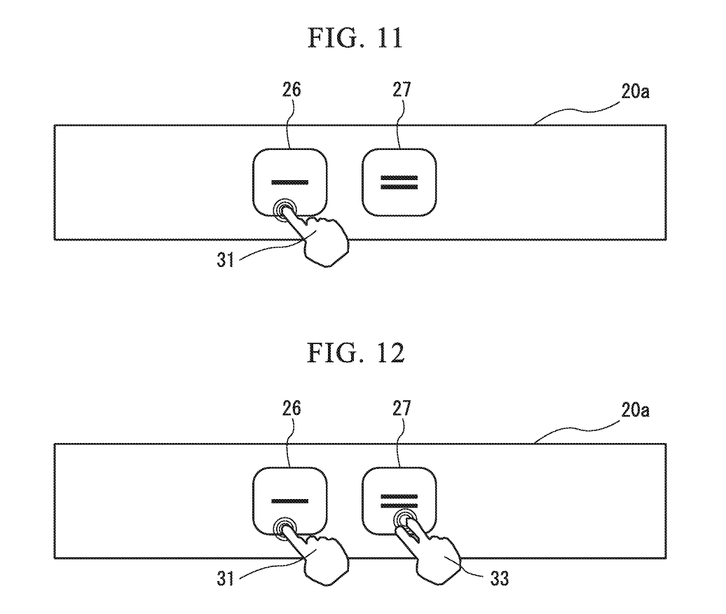

In addition, it is possible to make the color setup menu 20 in a hierarchical structure. After a user selects a color on the color setup menu 20, for example, the electronic blackboard system 10 may display a setup menu 20a showing shapes of lines in FIG. 11. The setup menu 20a shown in FIG. 11 includes an icon 26 for selecting a single line and an icon 27 for selecting two lines. A single line having the color is depicted on screen when the icon 26 is touched by an input object, i.e. when an input operation is carried out with the shape of an input object at the time of selecting the color in a rendering process. On the other hand, two lines having the color is depicted on screen when the icon 27 is touched by an input object, i.e. when an input operation is carried out with the shape of an input object at the time of selecting the color in a rendering process.

It is possible to coordinate the details of a rendering process with the shape of an input object with reference to only the setup menu 20a instead of the color setup menu 20. When the electronic blackboard system 10 is used in a monochrome display mode, for example, the shape of a line and the shape of an input object are set up on the setup menu 20a. In this case, as shown in FIG. 12, a single-line rendering operation is coordinated with the shape of the input object 31 touching the icon 26 on the setup menu 20a. In addition, a two-line rendering operation is coordinated with the shape of the input object 33 touching the icon 27. In this case, it is possible for a user to set a single line for the input shape of the input object 31, while it is possible for a user to set two lines for the input shape of the input object 33.

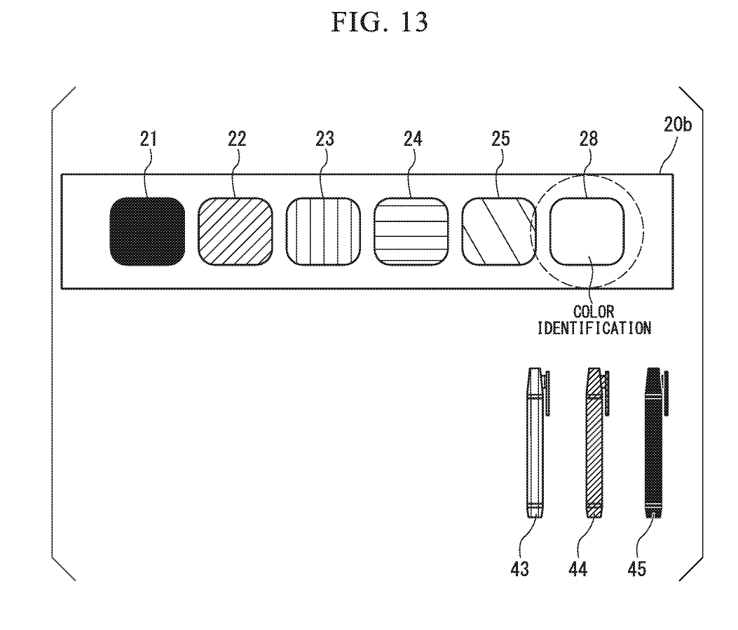

In addition, it is possible to set the coordination between an input object and its color by use of general-purpose pens having different colors. As shown in FIG. 13, an icon 28 for designating a color identification process on a setup menu 20b. For the sake of setting, a user may prepare a single general-purpose pen or multiple general-purpose pens 43 to 45 having different colors. In this case, the pen 43 is blue, the pen 44 is red, and the pen 45 is black. All the pens 43 to 45 may have the same shape or different shapes. A user may putting caps onto the pens 43 to 45 and then touches the icon 28 using the pens 43 to 45. The electronic blackboard system 10 recognizes the shape and the color for each of the pens 43 to 45, and therefore it sets black as a rendering color by the pen 43, it sets blue as a rendering color by the pen 44, and it sets black as a rendering color by the pen 45. In this modification, it is possible to change the details of processing depending on the touched position of each pen. For example, a color is designated by touching the icon 28 with one end of each pen, while an eraser is designated by touching the icon 28 with another end of each pen.

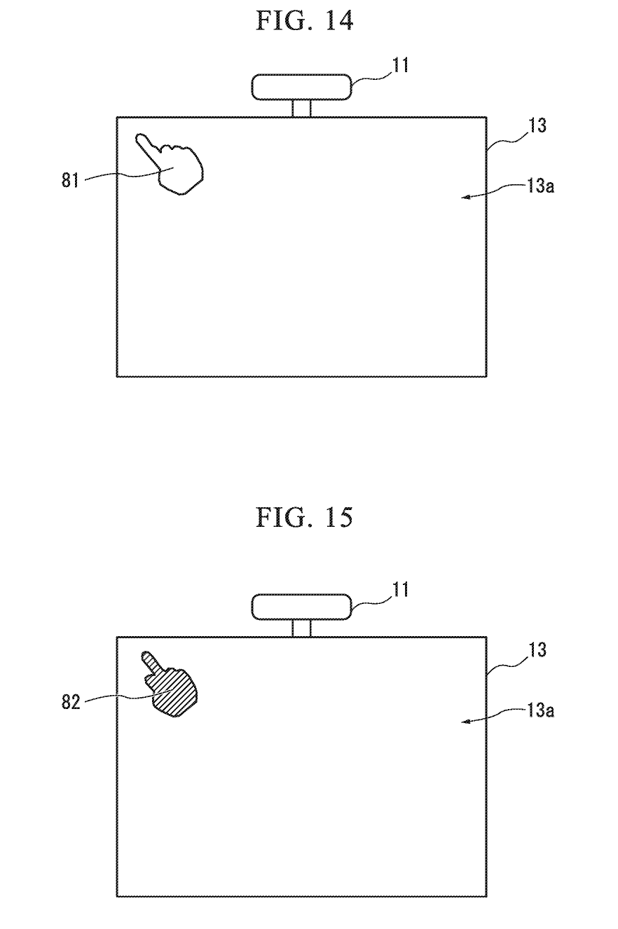

As shown in FIGS. 14 and 15, for example, it is possible to display coordination between the shape of the recognized input object and its color by means of an icon 81 or an icon 82 on the screen 13a. When a touch operation using an index finger is recognized as shown in FIG. 14, for example, the icon 81 having the shape to show a touch operation using an index finger is displayed in black. When a touch operation using a middle finger is recognized as shown in FIG. 15, for example, the icon 82 having the shape to show a touch operation using a middle finger is displayed in red.

In this connection, it is possible to normally display the icon 81 or the icon 82 on the screen 13a until other shapes and colors are recognized, or it is possible to display the icon 81 or the icon 82 on the screen 13a for a certain period of time when each icon is changed in shape or color. When each icon is normally displayed on the screen 13a, a user may normally recognize the color of the information that can be currently shown on the screen 13a. When the color is not a preferable color, for example, a user may take an action to change the shape of his/her finger again. On the other hand, when each icon is displayed on the screen 13a for a certain period of time at the time of changing each icon in shape or color, the displayed icon may not visually discomfort users.

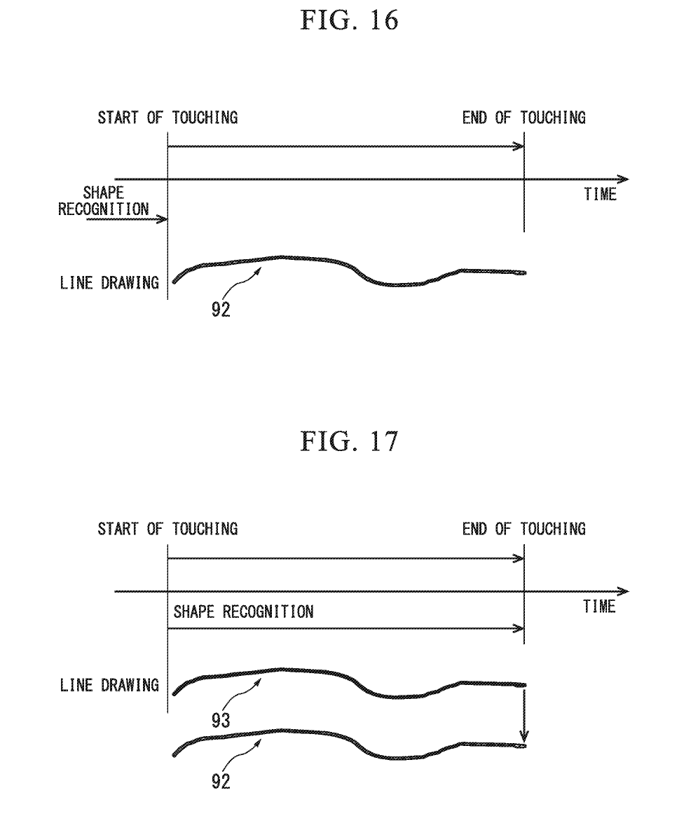

Two scenarios can be provided for the timing of changing the rendering color. That is, one scenario is to carry out a rendering process using the preset color when starting a touch operation while another scenario is to change a current color to the preset color when terminating a touch operation. To change colors upon starting a touch operation, as shown in FIG. 16, a line drawing 92 is depicted in the color coordinated with the shape recognized just before starting a touch operation. To change colors upon terminating a touch operation, as shown in FIG. 17, a line drawing 93 is temporarily depicted in a previous color before changing or in a standard color, and then the line drawing 92 is depicted again in the color coordinated with the shape recognized while depicting the line drawing 93 after terminating a touch operation. Alternatively, it is possible to depict the line drawing 92 in the color depending on the recognition result after terminating a touch operation without depicting the line drawing 93.

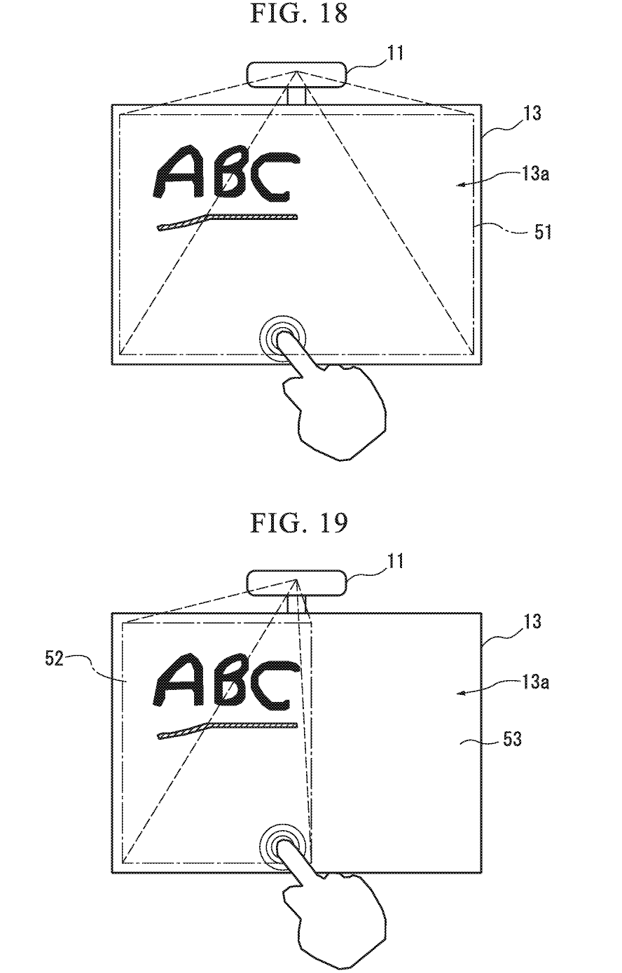

The setting regarding the coordination between the details of a rendering process and the shape and color of an input object may be uniformly determined with respect to the entirety of the screen 13a. Alternatively, it is possible to divide the screen 13a into multiple partial regions so as to change settings for each partial region. As shown in FIG. 18, for example, it is possible to determine a single region 51 covering the entirety of the screen 13a as an input and rendering region. In this case, it is possible to carry out a rendering process in the region 51 while changing the details of a rendering process depending on the shape and color of an input object. Alternatively, as shown in FIG. 19, it is possible to determine a region 52 covering the half of the screen 13a, and therefore it is possible to carry out a rendering process only in the region 52 while changing the details of a rendering process depending on the shape and color of an input object. In addition, it is possible to prevent inputting and rendering processes from being carried out in a remaining region 53. In this case, a rendering process to be executed in the region 53 depending on an inputting operation is no longer determined.

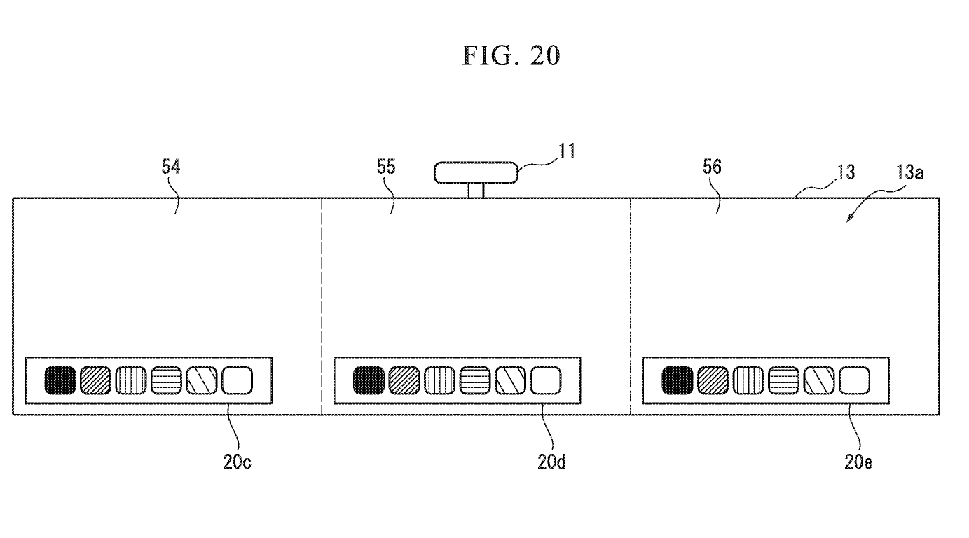

As shown in FIG. 20, for example, it is possible to divide the screen 13a into multiple regions 54, 55, and 56, and therefore it is possible to change the setting regarding the coordination between the details of a rendering process and the shape and color of an input object differently for each region. In this case, it is possible to display color setup menus 20c, 20d, and 20e separately with respect to the regions 54, 55, and 56.

The image pickup part 11 is not necessarily limited to cameras; hence, the image pickup part 11 can be embodied by using infrared sensors or by using combinations of cameras and infrared sensors. The electronic blackboard system is not necessarily limited to systems using liquid crystal displays; hence, the electronic blackboard system can be embodied using projectors. In addition, input objects should not be limited to the foregoing ones; hence, it is possible to employ any objects that are able to identify shapes and colors and that are hard to damage the screen 13a. For example, the touch panel 13 may be exemplified by touch panels installed in tablet terminals or smartphones. In this case, the image pickup part 11 may be formed using an in-camera embedded in a tablet terminal or a smartphone and a prism which is externally provided to capture an image of an input object.

It is possible to establish the correspondence between the constituent elements of the first embodiment and the constituent elements of the second embodiment as follows. The control device 1 shown in FIG. 1 may correspond to the entirety of the electronic blackboard system 10 or a single unit of the controller 12 shown in FIG. 2. The touch detector 2 shown in FIG. 1 may correspond to the detector 18, a combination of the detector 18 and the determination processing part 15, or the determination processing part 15 shown in FIG. 2. The image capture part 3 shown in FIG. 1 may correspond to the image pickup part 11, a combination of the image pickup part 11 and the image recognition processor 14, or the image recognition part 14 shown in FIG. 2. In addition, the processing determination part 4 shown in FIG. 1 may correspond to the determination processing part 15 shown in FIG. 2.

### Third Embodiment

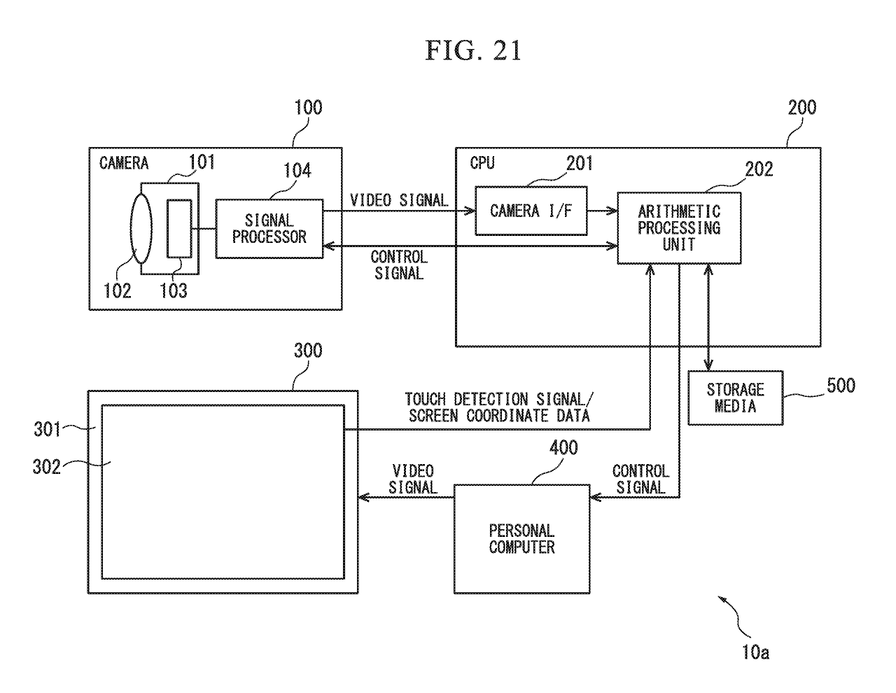

Next, the third embodiment of the present invention will be described with reference to the drawings. FIG. 21 is a block diagram diagrammatically showing an example of the configuration of an electronic blackboard system 10a. The electronic blackboard system 10a shown in FIG. 21 includes a camera 100, a CPU 200, a touch panel 300, a personal computer (hereinafter, referred to as a PC) 40, and a storage media 500.

The camera 100 includes an optical module 101 and a signal processor 104. The optical module 101 includes an optical system 102 and an image pickup device 103. The image pickup device 103 is a CMOS (Complementary Metal Oxide Semiconductor) image sensor, a CCD (Charge-Coupled Device) image sensor, or the like. The signal processor 104 reads pixel values from the image pickup device 103 and thereby carries out signal processing for the read pixel values so as to convert them into video signals having a predetermined format, so that video signals are output from the signal processor 104. Based on control signals output from the CPU 200, the signal processor 104 controls the optical system 102, controls the image pickup device 103, and change the details of signal processing.

The touch panel 300 includes a liquid-crystal display device 301 and a touch sensor 302. The liquid-crystal display device 301 displays videos based on video signals output from the PC 400. The touch sensor 302 detects a touch operation on the display screen of the liquid-crystal display device 301 so as to produce a touch detection signal representing the detected touch operation and screen coordinate data representing the touched position.

The CPU 200 includes a camera interface 201 and an arithmetic processing unit 202. The camera interface 201 is circuitry for inputting video signals output from the camera 100 into the arithmetic processing unit 202. The arithmetic processing unit 202 inputs a touch detection signal and screen coordinate data from the touch panel 300. For example, the arithmetic processing unit 202 outputs a control signal to the camera 100 so as to control the image capturing timing. In addition, the arithmetic processing unit 202 outputs a control signal to the PC 400 so as to indicate an image to be rendered.

The storage media 500 stores a table representing the correspondence between data extracting features such as the shape and color of an input object and a process coordinated with the shape and color of an input object. For example, the storage media 500 is a rewritable nonvolatile memory device which can be detachably attached to the CPU 200.

According to a control signal input from the CPU 200 and the information representing an operation screen for videos and applications designated by a user, the PC 400 generates images to be displayed on the touch panel 300, thus outputting video signals having a predetermined format.

The operation regarding a setting process and a rendering process depending on a touch operation with the electronic blackboard system 10a according to the third embodiment is identical to the operation of the electronic blackboard system 10 according to the second embodiment. In this connection, the camera 100 of the third embodiment may correspond to the image pickup part 11 of the second embodiment. In addition, the touch panel 300 of the third embodiment may correspond to the touch panel 13 of the second embodiment. Moreover, a combination of the CPU 200, the PC 400, and the storage media 500 according to the third embodiment may correspond to the controller 12 of the second embodiment.

According to the third embodiment similar to the second embodiment, it is possible to determine processes to be executed depending on the result of detecting touch operations and the captured images; hence, it is possible to improve operability with ease. When the storage media 500 can be detachably attached to the CPU 200, it is possible to easily update the information representing the coordination between the shape and color of an input object and its process. The third embodiment provides a simple configuration achieving an function of displaying an operation screen for application programs with the PC 400 and a function of displaying combinations of characters and lines, which are written into the touch panel 300, on the touch panel 300.

Heretofore, the foregoing embodiments of the present invention have been described in detail with reference to the drawings; however, the detailed configurations should not be limited to the foregoing embodiments; hence, the present invention may embrace any designs not departing from the essence of the invention.

### REFERENCE SIGNS LIST

1 control device
2 touch detector
3 image capture part
4 process determination part
10, 10a electronic blackboard system
11 image pickup part
12 controller
13 touch panel
13a screen
14 image recognition processor
15 determination processing part
16 coordinate storage media
17 rendering processor
18 detector
19 display
21-26 icon (first icon)
28 icon (second icon)
81, 82 icon (third icon)

1. A control method comprising:
detecting a touch operation using an input object;
capturing an image including at least part of the input object; and
determining a process to be executed depending on a detected touch operation of the input object and a captured image.

2. The control method according to claim 1, wherein the process is determined in coordination with a shape and/or a color of the input object which is stored in advance.

3. The control method according to claim 2, wherein the process is determined by recognizing the shape and/or the color of the input object from the captured image.

4. The control method according to claim 2, wherein the shape and/or the color of the input object is recognized depending on the detected touch operation of the input object and the captured image so as to coordinate the process with the shape and/or the color of the input object.

5. The control method according to claim 4, further comprising: displaying a first icon representing the process; and coordinating the process indicated by the first icon with the shape and/or the color of the input object touching the first icon.

6. The control method according to claim 5, further comprising: displaying a second icon representing a color identification process; and coordinating the process with the color of the input object touching the second icon.

7. The control method according to claim 1, wherein the process is determined at a time of starting or terminating the touch operation.

8. The control method according to claim 6, further comprising displaying a third icon representing the process determined.

9. The control method according to claim 8, wherein the third icon is displayed for a predetermined time upon changing the process determined.

10. The control method according to claim 1, wherein the process is determined for each of multiple partial regions on a display screen of a display device.

11. The control method according to claim 10, wherein the process is not determined for at least one of the multiple partial regions of the display device.

12. An electronic blackboard system comprising:
a detector configured to detect a touch operation using an input object;
an image capture part configured to capture an image including at least part of the input object;
a controller configured to determine a process depending on a detection result of the detector and a captured image of the image capture part; and
a display configured to display an image according to the process determined by the controller.

13. The electronic blackboard system according to claim 12, wherein the controller determined the process coordinated with a shape and/or a color of the input object, which are stored in advance.

14. The electronic blackboard system according to claim 13, wherein the controller recognizes the shape and/or the color of the input object from the captured image so as to determine the process.

15. The electronic blackboard system according to claim 14, wherein the controller recognizes the shape and/or the color of the input object depending on the detection result of the detector and the captured image of the image capture part and thereby sets coordination between the process and the shape and/or the color of the input object recognized.

16. The electronic blackboard system according to claim 15, wherein the controller displays a first icon representing the process and then coordinates the process indicated by the first icon with the shape and/or the color of the input object touching the first icon.

17. The electronic blackboard system according to claim 15, wherein the controller displays a second icon representing a color identification process and then coordinates the process with the color of the input object touching the second icon.

18. The electronic blackboard system according to claim 12, wherein the controller determines the process at a time of starting or terminating the touch operation.

19. A display device comprising: a detector configured to detect a touch operation using an input object; an image capture part configured to capture an image including at least part of the input object; a controller configured to determine a process to be executed depending on a detection result of the detector and a captured image of the image capture part; and a display configured to display the image according to the process determined by the controller.

20. (canceled)

21. The electronic blackboard system according to claim 16, wherein the controller sets the coordination by displaying a second icon representing a color identification process and then coordinating the determined process with the color of the input object touching the second icon.
